(19) United States
(12) Patent Application Publication
(10) Pub. No.: US 2008/0003077 A1
(43) Pub. Date: Jan. 3, 2008

(54) Latch assembly

(76) Inventor: Ormand Gilbert Anderson, Woodstock, GA (US)

Correspondence Address: KING & SPALDING LLP, 1180 PEACHTREE STREET, ATLANTA, GA, 30309-3521, US

(21) Appl. No.: 11/031,758

(22) Filed: Jan. 6, 2005

(51) Int. Cl. F16B 21/00

(52) U.S. Cl. 411/347

(57) ABSTRACT

A latch assembly for releasably fastening two elements is disclosed. The latch assembly comprises a housing; a plunger for sliding in the housing; at least one arm, pivotally secured to the plunger, for retractably extending through an opening in the housing; and a spring for urging the plunger out of the housing.

### TECHNICAL FIELD

This disclosure generally relates to latch assemblies for releasably connecting two elements, and, more particularly, to latch assemblies for use with luminaires.

### BACKGROUND

The “INESA Lighting Handbook” published by the Illuminating Engineering Society of North America, is incorporated by reference here in its entirety. As discussed in chapter seven of that handbook, a “luminaire” is a device for producing, controlling, and distributing light. It is typically a complete lighting unit consisting of one or more lamps, sockets for positioning and protecting the lamps and for connecting the lamps to a supply of electric power, optical devices for distributing the light, structural components for protecting the luminaire, and mechanical components for supporting or attaching the luminaire. Luminaires are also sometimes referred to as “light fixtures.”

Typically, luminaires can be classified by their application, such as indoor use or outdoor use. However, it is not uncommon for a particular luminaire to be used in both applications. As well, it is common for luminaires used outdoors and/or indoors to be mounted within a protective housing. For example, whereas a luminaire used indoors may require a housing to prevent physical contact with the luminaire and subsequent damage, a luminaire used outdoors may require a protective housing to prevent both damage from physical contact and damage from the weather and related elements. The protective housings may include removable access panels to facilitate maintenance, such as lamp replacement.

Various latches for use on the noted access panels are known. Existing latches are typically complex structures including numerous parts. The complex construction and multiple parts increase manufacturing costs and often require skilled assembly of the latch when installing the latch onto the protective housing or access panel of the luminaire. Complex construction and multiple parts also lend themselves to the failure of various components, and subsequent failure of the latch. Failed latches can cause access panels to open inadvertently, thereby exposing the luminaire within the protective housing to increased damage risks. Thus, damaged latches are preferably replaced or fixed to maintain the protective integrity of the housing, thereby increasing maintenance costs.

Conventional latches are often difficult to operate. For example, many require an individual to use both hands, and/or require one or more tools, to open and close the latch. The latches requiring the use of tools and/or both hands of the individual often create safety concerns. For example, housed luminaires are frequently mounted in elevated locations such as tall lighting poles, the tops of walls, or suspended from ceilings. Thus, stepladders, hydraulic lifts, and similar devices may be used to reach the luminaire. Accordingly, ease of operation of the latch and the ability of the individual to maintain his or her balance when using lifts, ladders, or similar devices is paramount. As well, existing latches typically require precise alignment during closure and provide no audible feedback to indicate the latch has been properly engaged, thereby further complicating operation of the latch.

One existing means for coupling or locking two parts together is disclosed in U.S. Pat. No. 3,669,441 to Bergman. One part is provided with a conical stud which can be inserted against a stop in a conical recess in another part. One, or preferably two or more, spring actuated latching members are pivotally attached to the stud about shafts at right angles to the axial direction of the stud and are free to enter an enlarged section of the recess. The latching members act like barbs of a hook or harpoon, thereby preventing the stud from returning. An operating device, rotatable or axially displaceable within the stud, and actuated from one or both ends thereof, is used to effectuate the return of the latching members.

However, the spring actuated latching members disclosed in U.S. Pat. No. 3,669,441 would not be preferable to use in various lighting applications for at least the reason that the latching members, being attached to the exterior housing (the conical stud), would apparently be exposed to the environment.

### SUMMARY

These and other drawbacks of such conventional technologies are addressed here by providing a latch assembly for releasably fastening two elements. For example, the elements may be a luminaire housing and an access panel for the luminaire housing. One embodiment of a latch comprises a housing; a plunger for sliding in the housing; at least one arm, pivotally secured to the plunger, for retractably extending through an opening in the housing; and a spring for urging the plunger out of the housing.

One embodiment may further comprise a second spring for urging the arm out of the opening. The latch may be configured such that one of the housing and plunger includes a guide slot, and the other of the housing and the slot includes a pin for extending into the slot and guiding the plunger in the housing. The exterior of the housing may include a flange and threads for engaging a fastener on one side of the flange.

In one embodiment of the fastener, the arm includes a reduced width at a free end thereof for engaging a coupling surface of a first element. The first element may be a luminaire housing, for example. The latch may be configured such that one of the housing and plunger include a guide slot, and the other of the housing and the slot includes a pin for extending into the slot and guiding the plunger in the housing. The exterior of the housing may include a flange and threads for engaging a fastener on one side of the flange.

In another embodiment, the exterior of the housing may include a flange and threads for engaging a fastener on one side of the flange.

In yet another embodiment, the latch may be configured such that one of the housing and plunger includes a guide slot, and the other of the housing and the slot includes a pin for extending into the slot and guiding the plunger in the housing.

Another embodiment of the technology is a latch including a housing; means for sliding in the housing; means, pivotally secured to the plunger, for retractably extending through an opening in the housing; and means for urging the plunger out of the housing. The latch further comprises second means for urging the arm out of the opening. The latch may further be configured such that one of the housing and means for sliding in the housing includes a means for guiding, and the other of the housing and the slot include means for extending into the means for guiding.

In another embodiment of the latch, the means for retractably extending through an opening includes a means, with a reduced width at a free end thereof, for engaging a coupling surface of a first element. The embodiment may be further configured such that one of the housing and the means for sliding in the housing include means for guiding, and the other of the housing and the slot include means for extending in the means for guiding. An exterior of the housing may include a flange and means for engaging a fastener on one side of the flange.

Another embodiment of the latch may be configured such that one of the housing and means for sliding in the housing includes a means for guiding, and the other of the housing and the slot includes means for extending into the means for guiding.

In yet another embodiment, an exterior of the housing of the latch includes a flange, and means for engaging a fastener on one side of the flange.

### BRIEF DESCRIPTION OF THE DRAWINGS

Various aspects of the invention will now be described with reference to the following figures (“FIGS.”) in which the same reference numerals are used to designate corresponding parts throughout each of the several views.

FIG. 1 is a perspective view of a latch assembly in accordance with the present disclosure.

FIG. 2 is a cross-sectional view of the latch assembly in FIG. 1.

FIG. 3 is a cross-sectional view of the latch assembly in FIG. 1.

FIG. 4 is a cross-sectional view of an alternate embodiment of a latch assembly in accordance with the present disclosure.

FIG. 5 is a cross-sectional view of the latch assembly of FIG. 1 during closure operations.

FIG. 6 is a cross-sectional view of the latch assembly of FIG. 1 during closure operations, in the closed position.

FIG. 7 is a cross-sectional view of the latch assembly of FIG. 1 during closure operations.

FIG. 8 is a cross-sectional view of the latch assembly of FIG. 1 during closure operations.

FIG. 9 is a cross-sectional view of the latch assembly of FIG. 1 during opening operations.

### DETAILED DESCRIPTION OF THE PREFERRED EMBODIMENTS

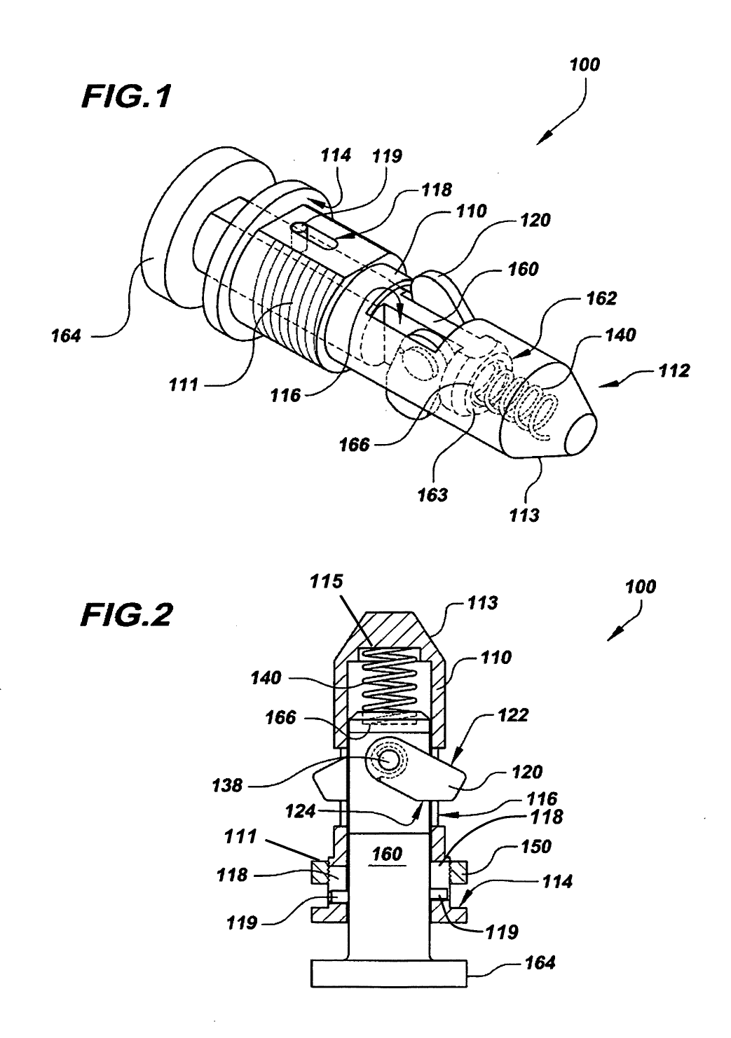

Referring now to FIGS. 1-3, a latch assembly 100 in accordance with the present disclosure is shown. The latch assembly 100 includes a hollow housing 110 and a plunger 160 slidably received therein. Plunger 160 includes a proximal end 164 which is capable of transmitting an external force to plunger 160. Proximal end 164 may, for example, comprise a head formed integrally with plunger 160, or may comprise a separate head attachable to plunger 160 via, for example, a threaded connection. In one embodiment, proximal end 164 may include a cap (not shown), constructed of a durable material such as thin sheet metal, for covering the head. Accordingly, the separate head and/or the cap may be painted separately (e.g. via powder coating) from the remainder of latch assembly 100 to provide a more finished and aesthetically pleasing appearance without subjecting the entire latch assembly 100 to masking or to the high temperature of a powder-coat paint system.

A pin 119 (preferably a set screw) extends outwardly from the plunger 160 into a longitudinal guide slot 118 formed in the hollow housing 110. Interaction between the longitudinal guide slot 118 and the pin 119 limits the fore and aft travel of the plunger 160 within the hollow housing 110. Furthermore, the pin guides the plunger 160 in the hollow housing 110.

As best shown in the cross-section of FIG. 2, both ends of pin 119 extend outwardly from plunger 160 into corresponding guide slot 118, formed in each side of the hollow housing 110. For example, during the assembly of latch 100, plunger 160 may be inserted into hollow housing 110. Then, pin 119 may be pushed through a hole in plunger 160 until both ends of pin 119 extend outwardly from plunger 160 and into the associated guide slot 118, thereby securing plunger 160 within hollow housing 110.

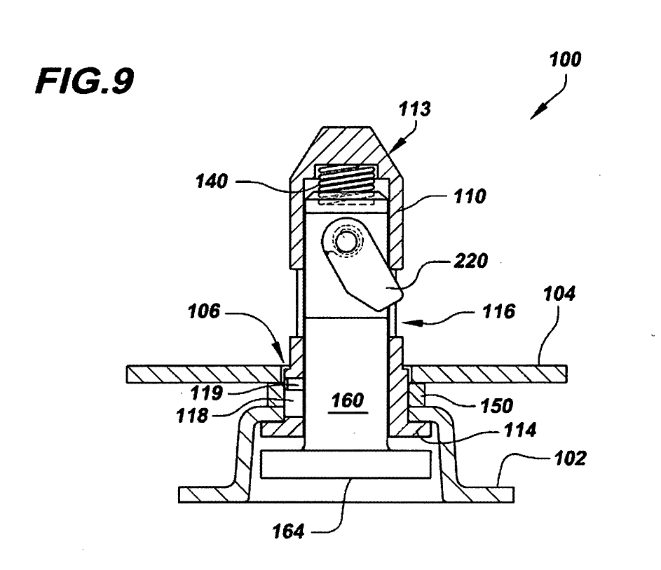

Other embodiments, such as the embodiment depicted in FIG. 9, may include only a single guide slot 118, with only a single end of pin 119 extending outwardly from plunger 160. Additionally, although the pin 119 and guide slot 118 have been described as being located on the plunger and housing, respectively, it should be understood that the latch could be configured such that a pin extends inwardly from the hollow housing and into a slot within the plunger.

A spring 140 is positioned within the hollow housing 110 between the distal end 112 of the hollow housing 110 and the distal end 162 of the plunger 160. In the extended position shown in FIG. 1, the spring 140 urges the plunger 160 outwardly from the hollow housing 110, the outward motion of the plunger 160 being limited by the pin 119 abutting the back end of the longitudinal guide slot 118. As shown in FIG. 2, opposing ends of the spring 140 are seated within recesses 115 and 166 formed in the distal ends 112 and 162 of the hollow housing 110 and plunger 160, respectively.

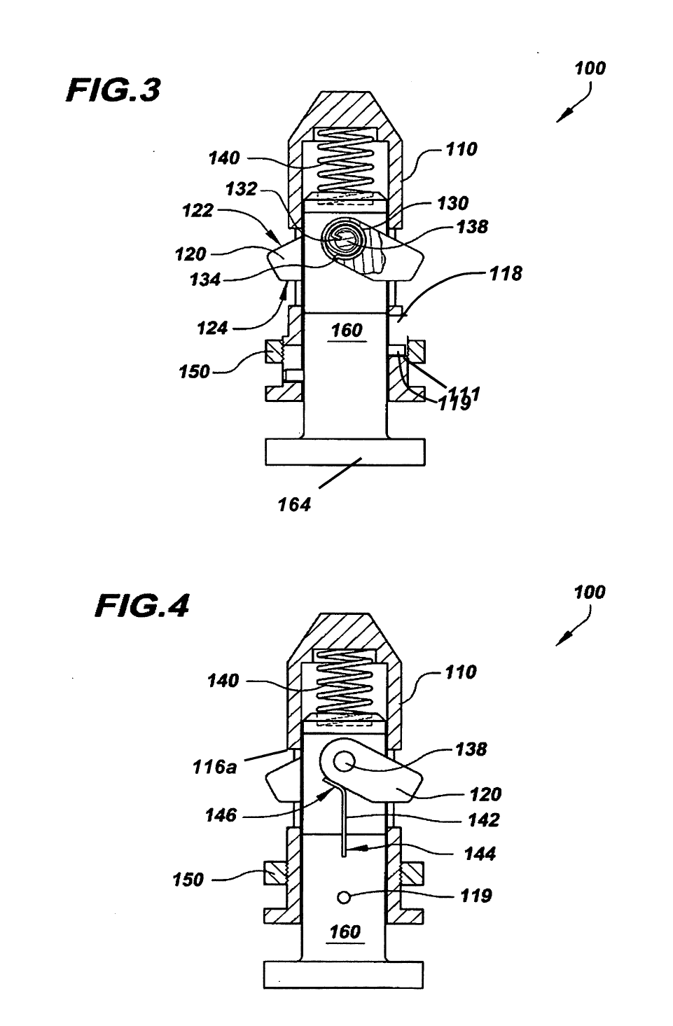

As best shown in FIGS. 2 and 3, the latch assembly 100 includes a pair of arms 120 pivotally secured to the plunger 160 on opposite ends of a pivot pin 138. A pair of openings 116 are provided on the hollow housing 110 such that an end portion of each arm 120 retractably extends through and beyond the outer diameter of the hollow housing 110 when the spring 140 is in the extended position. In this example, no substantial inward pressure is being exerted on the plunger 160 by spring 140. However, in other embodiments the spring may be configured to exert some force on plunger 160, even in the extended position.

Outward force is exerted on each arm 120 by a pair of flat coil springs 130, one flat coil spring 130 being provided for each arm 120, as shown in FIG. 3. Each flat coil spring 130 has a first end 132 secured to the pivot pin 138, such as in a recess, and a second end 134 secured to the respective arm 120, such as in a recess.

As discussed in Marks' Standard Handbook for Mechanical Engineers, eighth edition, which is also incorporated by reference herein its entirety, a mechanism is that part of a machine which contains two or more pieces so arranged that the motion of one compels the motion of the others according to a definite law depending upon the nature of the combination. Cams are one such mechanism. A cam is usually a plate or cylinder which communicates motion to a follower by means of its edge or a groove cut in its surface.

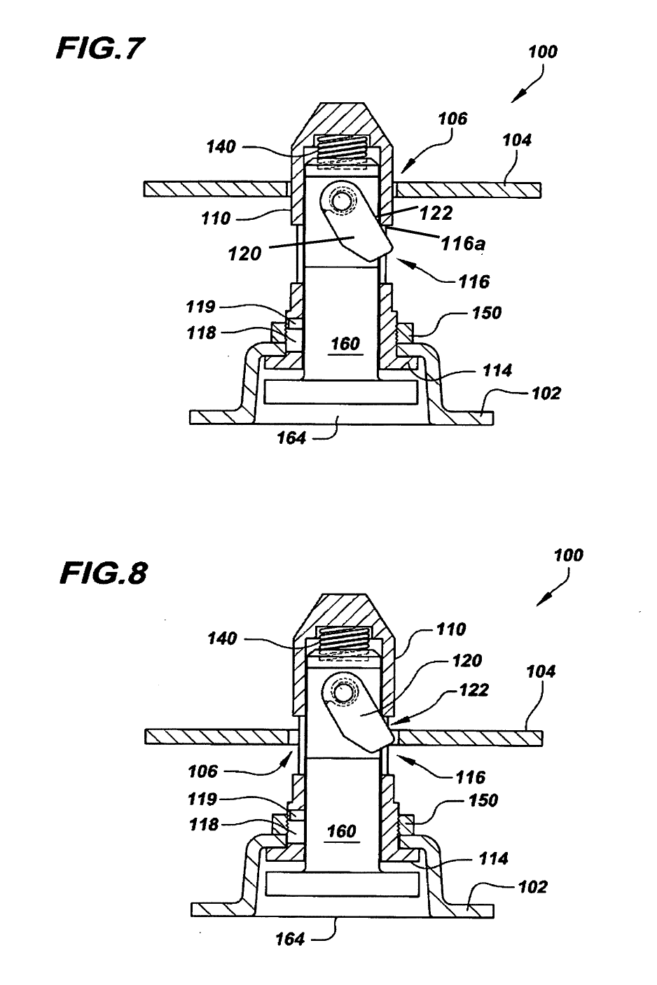

As noted, in the extended position, each flat coil spring 130 urges the respective arm 120 outwardly, through the respective opening 116. However, as force is exerted on the proximal end 164 of the plunger 160, the plunger 160 slides into the hollow housing 110, causing a camming surface 122 of each arm 120 to engage the leading edge 116a of the respective opening 116, which acts as the cam. Additional inward motion of the plunger 160 relative to the hollow housing 110 causes each arm 120, which acts as a cam follower, to be rotated inwardly as the camming surface 122 interacts with the leading edge 116a of the opening 116. The continued inward motion of the plunger 160 overcomes the outward force exerted by each flat coil spring 130 on the respective arm 120. Eventually, each arm is fully retracted within the outer diameter of the hollow housing 110 (FIG. 7).

One potential advantage of the described latch is the protection afforded to the arms 120, pivot pin 138, and the flat coil spring 130, all of which are attached to the plunger 160 and located within the hollow housing 110. Thus, with the exception of the portion of the arms 120 which extend outwardly from the housing when spring 140 is in the extended position, the moving parts of the device are hidden and protected from weather and other potential damage.

In the embodiment shown, the proximal end of hollow housing 110 includes a flange 114 extending outwardly therefrom and a threaded barrel 111. The threaded barrel 111 is configured to receive a fastener such as threaded nut 150. Threaded nut 150 screws onto threaded barrel 111 to secure the latch assembly 100 to an element 102 (FIG. 5), which may be an access panel for a luminaire housing.

Specifically, to secure the latch assembly 100 to the access panel 102, a portion of the access panel 102 is secured between the threaded nut 150 and one side of the outwardly extending flange 114. Preferably, a self-locking, threaded nut 150 is used to prevent the latch assembly 100 from loosening due to repeated use. As well, the distal end 112 of the hollow housing 110 includes a beveled edge 113 about its circumference. The beveled edge 113 helps insure proper closure of the latch assembly 100, although the distal end 112 of hollow housing 110 and the mating receptacle 106 (FIG. 5) may be somewhat misaligned. Similarly, the distal end 162 of the plunger 160 also includes a beveled edge 163 to help ensure proper motion of the plunger 160 relative to hollow housing 110.

Another embodiment of latch assembly 100, shown in FIG. 4, includes a pair of sheet springs 142 to exert outward force on the pair of arms 120. Each sheet spring 142 includes a mounted end 144 disposed in a recess in the plunger 160 and a free end 146 in contact with the respective arm 120. As shown, the sheet spring 142 is in the extended position (in this case, not substantially deflected), thereby holding the arm 120 in an outward position from the hollow housing 120. As inward force is exerted on the arm 120, the arm 120 exerts force on the free end 146 of the sheet spring 142, causing the sheet spring 142 to deflect in the direction opposite of the applied force. After the applied force is removed, the sheet spring 142 returns to the extended position, thereby exerting outward force on the arm 120 with the free end 146. As such, the arm 120 extends outwardly through the adjacent opening 116.

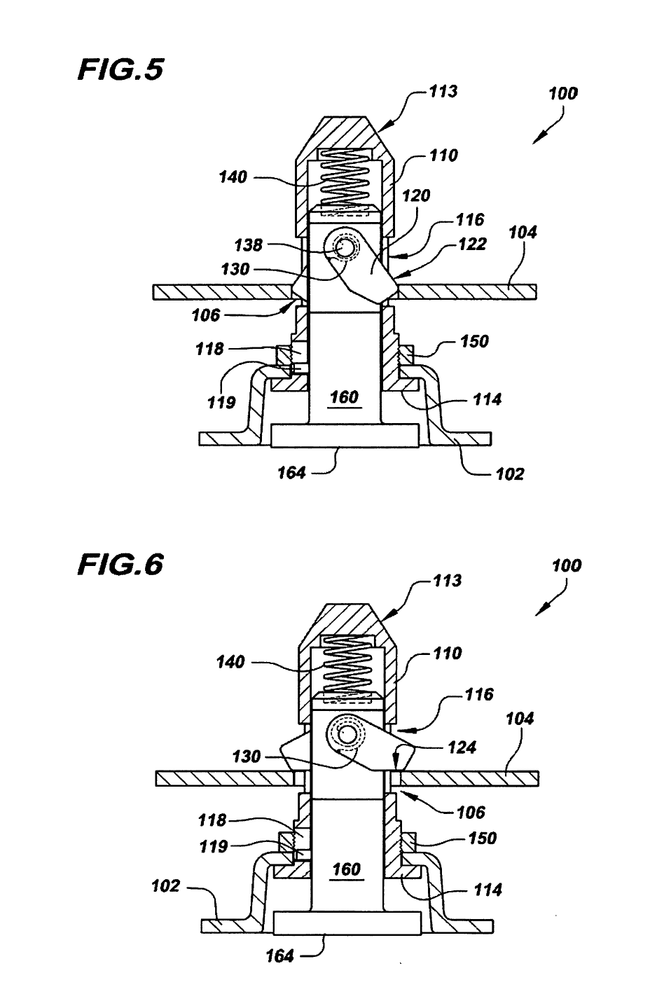

Referring now to FIGS. 5 and 6, the latch assembly 100 is used to secure an access panel 102 to a fixture housing 104. As previously described, the latch assembly 100 is secured to the access panel 102 by securing a portion thereof between the outwardly extending flange 114 of the hollow housing 110 and the threaded nut 150. As shown, the latch assembly 100 is secured to a recessed portion of the access panel so that the proximal end 164 of the plunger 160 is flush with the access panel 102 when the spring 140 is in the extended position.

FIGS. 5 and 6 depict the operation of securing the access panel 102 to fixture housing 104 by means of an individual exerting force on the access panel 102 rather than the plunger 160. As the latch assembly 100 passes through the mating receptacle 106 formed in the fixture housing 104, the camming surface 122 of each arm 120 will eventually come into contact with a portion of the circumference of the mating receptacle 106. As such, the mating receptacle 106 causes both arms 120 to rotate inwardly until contact between the arms and the mating receptacle 106 ceases, meaning the arms 120 have passed fully through the mating receptacle 106. Note, the mating receptacle 106 can be formed directly in the wall of the fixture housing 104 (as shown) or can be formed on a separate member that is then mounted to the fixture housing 104.

Once this contact is ceased, the constant outward force exerted by each flat coil spring 130 on the respective arm 120 causes the arm 120 to rotate outwardly until a portion of each arm 120 extends beyond the outer diameter of hollow housing 110. Once the arms 120 have rotated outwardly, the individual may cease exerting force on the access panel 102. The access panel 102 is now secured to the fixture housing, trapping the inner surface of the fixture housing 104 between abutment surfaces 124 of the arms 120 and the hollow housing, as shown in FIG. 6. The abutment surfaces 124 may comprise a reduced width at a free end of the arm. Depending on the orientation of the fixture, gravity may cause the abutment surfaces 124 of the arms 120 to rest against the inner coupling surface of the fixture housing 104. Closure of the access panel 102 can be obtained utilizing a single arm 120, but at least two are preferred.

Referring now to FIGS. 7 and 8, closure of the access panel 102 is shown, wherein the individual exerts force on the proximal end 164 of the plunger 160. Exerting force on the plunger 160 causes the plunger 160 to move inwardly relative to hollow housing 110 as the spring 140 is compressed. Eventually, as previously discussed, the camming surface 122 of each arm 120 will come into contact with the leading edge 116a of the respective opening 116. As such, continued inward motion of the plunger 160 relative to hollow housing 110 causes the arms 120 to rotate inwardly until they are located within the outer diameter of the hollow housing 110.

Eventually, inward motion of the plunger 160 relative to the hollow housing 110 will cease, due either to the spring 140 being fully compressed or the pin 119 abutting the forward edge of the longitudinal guide slot 118. At this time, further force exerted on the plunger 160 causes the access panel 102 to move toward the fixture housing 104 and the latch assembly 100 is inserted into the mating receptacle 106. As best seen in FIG. 8, both arms 120 are retracted prior to passing through the mating receptacle 106.

When the access panel 102 is closed by exerting force on the plunger 160 rather than the access panel 102, the arms 120 are not automatically returned to their fully extended positions. Rather, the force exerted on the plunger 160 is removed such that the spring 140 returns to its extended position. The spring 140 urges the plunger 160 downwardly with respect to hollow housing 110 such that the leading edge 116a of each opening 116 no longer exerts inward force on the respective arm 120. For example, with the latch assembly 100 positioned as shown in FIG. 9, the individual exerts upward force on the access panel 102 while securing upward force on the plunger 160. Once the spring 140 returns to the extended position and the arms 120 are outwardly extended, the individual then ceases to exert upward force on the access panel 102 and the abutment surfaces 124 of each arm 120 rest on the inner surface of the fixture housing 104, as shown in FIG. 6.

As shown in FIG. 9, to open the access panel, the individual exerts force on the plunger 160, causing inward motion of the plunger relative to the hollow housing 110. Subsequently, the arms 220 rotate inwardly within the outer diameter of the hollow housing 110, as previously discussed. Adequate clearance between arms 220 and fixture housing 104 should be provided such that the arms may freely rotate inwardly to the retracted position without impedance by fixture housing 104. It should be emphasized that the clearance provided in FIG. 9 for the arms to freely rotate inwardly is substantially more than required. Next, while maintaining adequate pressure on the plunger 160 to keep the arms 120 retracted, the individual exerts downward force on the access panel 102 such that the latch assembly 100 is removed from the mating receptacle 106. Once the arms 120 have cleared the mating receptacle 106, exertion of force on the plunger 160 is no longer required.

It should be emphasized that the embodiments described above, and particularly any “preferred” embodiments, are merely examples of various implementations that have been set forth here to provide a clear understanding of various aspects of the invention. One of ordinary skill will be able to alter many of these embodiments without substantially departing from scope of protection defined solely by the proper construction of the following claims.

1. A latch adapted to be secured to a panel, the latch comprising:
a housing comprising an opening, a flange extending radially from one end of the housing, and threads located on the exterior of the housing for engaging a fastener on one side of the flange so that at least a portion of the panel is secured between the one side of the flange and the fastener to secure the latch to the panel;
a plunger for sliding in the housing;
at least one arm, pivotally secured to the plunger, for retractably extending through the opening in the housing; and
a spring for urging the plunger out of the housing.

2. The latch recited in claim 1, further comprising a second spring for urging the arm out of the opening.

3. The latch recited in claim 1, wherein the arm includes a reduced width at a free end thereof.

4. The latch recited in claim 1, further comprising:
one of the housing and plunger having a guide slot; and
the other of the housing and the plunger having a pin for extending into the slot and guiding the plunger in the housing.

5. (canceled)

6. The latch recited in claim 2, further comprising:
one of the housing and plunger having a guide slot; and
the other of the housing and the plunger having a pin for extending into the slot and guiding the plunger in the housing.

7. (canceled)

8. (canceled)

9. The latch recited in claim 3, further comprising:
one of the housing and plunger having a guide slot; and
the other of the housing and the plunger having a pin for extending into the slot and guiding the plunger in the housing.

10-20. (canceled)

21. An apparatus comprising:
a fixture housing comprising a mating receptacle and a coupling surface;
an access panel adapted to be removably secured to the fixture housing; and
a latch assembly secured to the access panel and adapted to removably secure the access panel to the fixture housing, the latch assembly comprising:
a fastener;
a latch housing adapted to extend through the mating receptacle of the fixture housing, the latch housing comprising inner and outer diameters, a radially-extending opening, a flange extending radially from one end of the latch housing, and threads located on the exterior of the latch housing and engaging the fastener on one side of the flange so that at least a portion of the access panel is secured between the one side of the flange and the fastener to secure the latch assembly to the access panel;
a plunger at least partially extending in the latch housing and comprising a longitudinal length;
at least one arm pivotally secured to the plunger and adapted to retractably extend through the opening in the latch housing, the arm comprising a free end;
a first spring disposed in the latch housing for urging the plunger out of the latch housing; and
a second spring for urging the arm out of the opening;
wherein one of the latch housing and the plunger comprises a pin;
wherein the other of the latch housing and the plunger comprises a guide slot into which the pin extends to guide the plunger in the latch housing and limit the axial travel of the plunger within the latch housing;
wherein the latch assembly further comprises:
a first configuration in which:
a first portion of the longitudinal length of the plunger is disposed in the latch housing; and
the at least one arm extends through the opening in the latch housing;
and
a second configuration in which:
a second portion of the longitudinal length of the plunger is disposed in the latch housing, wherein the second portion of the longitudinal length of the plunger is greater than the first portion of the longitudinal length of the plunger;
the first spring is at least partially compressed by the plunger; and
the at least one arm is retracted and at least partially located
within the outer diameter of the latch housing;
and
wherein, when the access panel is removably secured to the fixture housing, the latch assembly is in its first configuration; and
the at least one arm is positioned proximate or against the coupling surface of the fixture housing.

22. The apparatus of claim 21, wherein the access panel comprises a first surface and a recessed portion in which the plunger at least partially extends, the recessed portion comprising a second surface;
wherein the one side of the flange of the latch housing abuts the second surface of the recessed portion of the access panel; and
wherein the plunger comprises an end that is generally flush with the first surface of the access panel when the access panel is removably secured to the fixture housing and the latch assembly is in its first configuration.

23. A method comprising:
providing a fixture housing comprising a mating receptacle and a coupling surface; and
removably securing an access panel to the fixture housing, comprising:
providing a latch assembly, comprising:
providing a longitudinally-extending latch housing comprising inner and outer diameters, and a radially-extending opening;
inserting a plunger into the latch housing; and
pivotly coupling at least one arm to the plunger, the at least one arm comprising a free end;
securing the latch assembly to the access panel;
exerting an outward force on the at least one arm so that at least a portion of the at least one arm retractably extends through the opening in the latch housing and beyond the outer diameter of the latch housing; and
positioning the free end of the at least one arm proximate or against the coupling surface of the fixture housing, comprising:
inserting at least a portion of the latch housing through the mating receptacle of the fixture housing;
retracting at least a portion of the at least one arm within the outer diameter of the latch housing so that the at least one arm is inserted through the mating receptacle of the fixture housing with the at least a portion of the latch housing, comprising:
causing the at least one arm to rotate inwardly, comprising:
overcoming the outward force exerted on the at least one arm, comprising at least one of the following:
causing a camming surface on the at least one arm to engage the leading edge of the opening in the latch housing; and
contacting a portion of the fixture housing with the camming surface on the at least one arm during inserting the at least a portion of the latch housing through the mating receptacle of the fixture housing;
and
after the at least a portion of the latch housing has been inserted through the mating receptacle, causing the at least one arm to rotate outwardly so that:
at least a portion of the at least one arm retractably extends through the opening in the latch housing and beyond the outer diameter of the latch housing,
the free end of the at least one arm is positioned proximate or against the coupling surface of the fixture housing, and
the access panel is removably secured to the fixture housing.

24. The method of claim 23 further comprising:
securing the plunger within the latch housing, comprising at least one of the following:
extending a pin from the plunger and into a guide slot formed in the latch housing; and
extending a pin from the latch housing and into a guide slot formed in the plunger;
urging the plunger outwardly from the latch housing; and
limiting the outward motion of the plunger in response to securing the plunger within the latch housing.

25. The method of claim 23 wherein causing the at least one arm to rotate outwardly comprises:
urging the plunger outwardly from the latch housing.

26. The method of claim 23 wherein inserting the at least a portion of the latch housing through the mating receptacle of the fixture housing comprises:
facilitating the alignment between the latch housing and the mating receptacle of the fixture housing.

27. The method of claim 23 further comprising:
unsecuring the access panel from the fixture housing, comprising:
exerting a force on the plunger;
causing inward motion of the plunger relative to the latch housing in response to exerting the force on the plunger;
rotating the at least one arm inwardly in response to the inward motion of the plunger relative to the latch housing; and
while maintaining the force on the plunger, exerting a force on the access panel in a direction away from the fixture housing so that the latch housing passes through the mating receptacle and the at least one arm clears the mating receptacle of the fixture housing.

28. The method of claim 27 further comprising:
protecting the at least one arm from damage during at least removably securing the access panel to the fixture housing and unsecuring the access panel from the fixture housing.

29. The method of claim 23 wherein the access panel comprises a surface and a recessed portion recessed from the surface; and
wherein securing the latch assembly to the access panel comprises:
securing the latch assembly to the recessed portion of the access panel so that an end of the plunger is substantially flush with the surface of the access panel when the at least a portion of the at least one arm retractably extends through the opening in the latch housing and beyond the outer diameter of the latch housing;

30. The method of claim 23 wherein, when overcoming the outward force exerted on the at least one arm comprises causing the camming surface on the at least one arm to engage the leading edge of the opening in the latch housing, positioning the free end of the at least one arm proximate or against the coupling surface of the fixture housing further comprises:
disposing a spring in the latch housing;
causing the plunger to move further inwardly relative to the latch housing, comprising exerting a force on the plunger;
compressing the spring in response to causing the plunger to move further inwardly relative to the latch housing;
generally preventing further inward motion of the plunger relative to the latch housing;
and
removing the force exerted on the plunger so that the spring urges at least a portion of the plunger out of the latch housing so that the at least one arm rotates outwardly.

31. The method of claim 23 wherein causing the camming surface on the at least one arm to engage the leading edge of the opening in the latch housing comprises:
exerting a force on the proximal end of the plunger so that the plunger is inserted further into the latch housing.

32. The method of claim 23 further comprising:
facilitating the motion of the plunger relative to the latch housing.

33. A method comprising:
providing a fixture housing comprising a mating receptacle and a coupling surface;
removably securing an access panel to the fixture housing, comprising:
providing a latch assembly, comprising:
providing a longitudinally-extending latch housing comprising inner and outer diameters, and a radially-extending opening;
inserting a plunger into the latch housing; and
pivotly coupling at least one arm to the plunger, the at least one arm comprising a free end;
securing the latch assembly to the access panel;
exerting an outward force on the at least one arm so that at least a portion of the at least one arm retractably extends through the opening in the latch housing and beyond the outer diameter of the latch housing; and
positioning the free end of the at least one arm proximate or against the coupling surface of the fixture housing, comprising:
inserting at least a portion of the latch housing through the mating receptacle of the fixture housing;
retracting at least a portion of the at least one arm within the outer diameter of the latch housing so that the at least one arm is inserted through the mating receptacle of the fixture housing with the at least a portion of the latch housing, comprising:
causing the at least one arm to rotate inwardly, comprising:
overcoming the outward force exerted on the at least one arm, comprising at least one of the following:
causing a camming surface on the at least one arm to engage the leading edge of the opening in the latch housing; and
contacting a portion of the fixture housing with the camming surface on the at least one arm during inserting the at least a portion of the latch housing through the mating receptacle of the fixture housing;
and
after the at least a portion of the latch housing has been inserted through the mating receptacle, causing the at least one arm to rotate outwardly so that:
at least a portion of the at least one arm retractably extends through the opening in the latch housing and beyond the outer diameter of the latch housing,
the free end of the at least one arm is positioned proximate or against the coupling surface of the fixture housing, and
the access panel is removably secured to the fixture housing;
unsecuring the access panel from the fixture housing, comprising:
exerting a force on the plunger;
causing inward motion of the plunger relative to the latch housing in response to exerting the force on the plunger;
rotating the at least one arm inwardly in response to the inward motion of the plunger relative to the latch housing; and
while maintaining the force on the plunger, exerting a force on the access panel in a direction away from the fixture housing so that the latch housing passes through the mating receptacle and the at least one arm clears the mating receptacle of the fixture housing;
protecting the at least one arm from damage during at least removably securing the access panel to the fixture housing and unsecuring the access panel from the fixture housing;
facilitating the motion of the plunger relative to the latch housing;
securing the plunger within the latch housing, comprising at least one of the following:
extending a pin from the plunger and into a guide slot formed in the latch housing; and
extending a pin from the latch housing and into a guide slot formed in the plunger;
urging the plunger outwardly from the latch housing;
and
limiting the outward motion of the plunger in response to securing the plunger within the latch housing;
wherein causing the at least one arm to rotate outwardly comprises:
urging the plunger outwardly from the latch housing;
wherein inserting the at least a portion of the latch housing through the mating
receptacle of the fixture housing comprises:
facilitating the alignment between the latch housing and the mating receptacle of the fixture housing;
and
wherein, when overcoming the outward force exerted on the at least one arm comprises causing the camming surface on the at least one arm to engage the leading edge of the opening in the latch housing, positioning the free end of the at least one arm proximate or against the coupling surface of the fixture housing further comprises:
disposing a spring in the latch housing;
causing the plunger to move further inwardly relative to the latch housing, comprising exerting a force on the plunger;
compressing the spring in response to causing the plunger to move further inwardly relative to the latch housing;
generally preventing further inward motion of the plunger relative to the latch housing; and
removing the force exerted on the plunger so that the spring urges at least a portion of the plunger out of the latch housing so that the at least one arm rotates outwardly.

34. A system comprising:
means for providing a fixture housing comprising a mating receptacle and a coupling surface; and
means for removably securing an access panel to the fixture housing, comprising:
means for providing a latch assembly, comprising:
means for providing a longitudinally-extending latch housing comprising inner and outer diameters, and a radially-extending opening;
means for inserting a plunger into the latch housing; and
means for pivotly coupling at least one arm to the plunger, the at least one arm comprising a free end;
means for securing the latch assembly to the access panel;
means for exerting an outward force on the at least one arm so that at least a portion of the at least one arm retractably extends through the opening in the latch housing and beyond the outer diameter of the latch housing; and
means for positioning the free end of the at least one arm proximate or against the coupling surface of the fixture housing, comprising:
means for inserting at least a portion of the latch housing through the mating receptacle of the fixture housing;
means for retracting at least a portion of the at least one arm within the outer diameter of the latch housing so that the at least one arm is inserted through the mating receptacle of the fixture housing with the at least a portion of the latch housing, comprising:
causing the at least one arm to rotate inwardly, comprising:
means for overcoming the outward force exerted on the at least one arm, comprising at least one of the following:
means for causing a camming surface on the at least one arm to engage the leading edge of the opening in the latch housing; and
means for contacting a portion of the fixture housing with the camming surface on the at least one arm during inserting the at least a portion of the latch housing through the mating receptacle of the fixture housing;
and
means for after the at least a portion of the latch housing has been inserted through the mating receptacle, causing the at least one arm to rotate outwardly so that:
at least a portion of the at least one arm retractably extends through the opening in the latch housing and beyond the outer diameter of the latch housing,
the free end of the at least one arm is positioned proximate or against the coupling surface of the fixture housing, and
the access panel is removably secured to the fixture housing.

35. The system of claim 34 further comprising:
means for securing the plunger within the latch housing, comprising at least one of the following:
means for extending a pin from the plunger and into a guide slot formed in the latch housing; and
means for extending a pin from the latch housing and into a guide slot formed in the plunger;
means for urging the plunger outwardly from the latch housing; and
means for limiting the outward motion of the plunger in response to securing the plunger within the latch housing.

36. The system of claim 34 wherein means for causing the at least one arm to rotate outwardly comprises:
means for urging the plunger outwardly from the latch housing.

37. The system of claim 34 wherein means for inserting the at least a portion of the latch housing through the mating receptacle of the fixture housing comprises:
means for facilitating the alignment between the latch housing and the mating receptacle of the fixture housing.

38. The system of claim 34 further comprising:
means for unsecuring the access panel from the fixture housing, comprising:
means for exerting a force on the plunger;
means for causing inward motion of the plunger relative to the latch housing in response to exerting the force on the plunger;
means for rotating the at least one arm inwardly in response to the inward motion of the plunger relative to the latch housing; and
means for while maintaining the force on the plunger, exerting a force on the access panel in a direction away from the fixture housing so that the latch housing passes through the mating receptacle and the at least one arm clears the mating receptacle of the fixture housing.

39. The system of claim 38 further comprising:
means for protecting the at least one arm from damage during at least removably securing the access panel to the fixture housing and unsecuring the access panel from the fixture housing.

40. The system of claim 34 wherein the access panel comprises a surface and a recessed portion recessed from the surface; and
wherein means for securing the latch assembly to the access panel comprises:
means for securing the latch assembly to the recessed portion of the access panel so that an end of the plunger is substantially flush with the surface of the access panel when the at least a portion of the at least one arm retractably extends through the opening in the latch housing and beyond the outer diameter of the latch housing;

41. The system of claim 34 wherein, when means for overcoming the outward force exerted on the at least one arm comprises means for causing the camming surface on the at least one arm to engage the leading edge of the opening in the latch housing, means for positioning the free end of the at least one arm proximate or against the coupling surface of the fixture housing further comprises:
means for disposing a spring in the latch housing;
means for causing the plunger to move further inwardly relative to the latch housing, comprising exerting a force on the plunger;
means for compressing the spring in response to causing the plunger to move further inwardly relative to the latch housing;
means for generally preventing further inward motion of the plunger relative to the latch housing; and
means for removing the force exerted on the plunger so that the spring urges at least a portion of the plunger out of the latch housing so that the at least one arm rotates outwardly.

42. The system of claim 34 wherein means for causing the camming surface on the at least one arm to engage the leading edge of the opening in the latch housing comprises:
means for exerting a force on the proximal end of the plunger so that the plunger is inserted further into the latch housing.

43. The system of claim 34 further comprising:
means for facilitating the motion of the plunger relative to the latch housing.

44. A system comprising:
means for providing a fixture housing comprising a mating receptacle and a coupling surface;
means for removably securing an access panel to the fixture housing, comprising:
means for providing a latch assembly, comprising:
means for providing a longitudinally-extending latch housing comprising inner and outer diameters, and a radially-extending opening;
means for inserting a plunger into the latch housing; and
means for pivotly coupling at least one arm to the plunger, the at least one arm comprising a free end;
means for securing the latch assembly to the access panel;
means for exerting an outward force on the at least one arm so that at least a portion of the at least one arm retractably extends through the opening in the latch housing and beyond the outer diameter of the latch housing; and
means for positioning the free end of the at least one arm proximate or against the coupling surface of the fixture housing, comprising:
means for inserting at least a portion of the latch housing through the mating receptacle of the fixture housing;
means for retracting at least a portion of the at least one arm within the outer diameter of the latch housing so that the at least one arm is inserted through the mating receptacle of the fixture housing with the at least a portion of the latch housing, comprising:
means for causing the at least one arm to rotate inwardly,
comprising:
means for overcoming the outward force exerted on the at least one arm, comprising at least one of the following:
means for causing a camming surface on the at least one arm to engage the leading edge of the opening in the latch housing; and
means for contacting a portion of the fixture housing with the camming surface on the at least one arm during inserting the at least a portion of the latch housing through the mating receptacle of the fixture housing;
and
means for after the at least a portion of the latch housing has been inserted through the mating receptacle, causing the at least one arm to rotate outwardly so that:
at least a portion of the at least one arm retractably extends through the opening in the latch housing and beyond the outer diameter of the latch housing,
the free end of the at least one arm is positioned proximate or against the coupling surface of the fixture housing, and
the access panel is removably secured to the fixture housing;
means for unsecuring the access panel from the fixture housing, comprising:
means for exerting a force on the plunger;
means for causing inward motion of the plunger relative to the latch housing in response to exerting the force on the plunger;
means for rotating the at least one arm inwardly in response to the inward motion of the plunger relative to the latch housing; and
means for while maintaining the force on the plunger, exerting a force on the access panel in a direction away from the fixture housing so that the latch housing passes through the mating receptacle and the at least one arm clears the mating receptacle of the fixture housing;
means for protecting the at least one arm from damage during at least removably securing the access panel to the fixture housing and unsecuring the access panel from the fixture housing;
means for facilitating the motion of the plunger relative to the latch housing;
means for securing the plunger within the latch housing, comprising at least one of the following:
means for extending a pin from the plunger and into a guide slot formed in the latch housing; and
means for extending a pin from the latch housing and into a guide slot formed in the plunger;
means for urging the plunger outwardly from the latch housing;
and
means for limiting the outward motion of the plunger in response to securing the plunger within the latch housing;
wherein means for causing the at least one arm to rotate outwardly comprises:
means for urging the plunger outwardly from the latch housing;
wherein means for inserting the at least a portion of the latch housing through the mating receptacle of the fixture housing comprises:
means for facilitating the alignment between the latch housing and the mating receptacle of the fixture housing;
and
wherein, when means for overcoming the outward force exerted on the at least one arm comprises means for causing the camming surface on the at least one arm to engage the leading edge of the opening in the latch housing, means for positioning the free end of the at least one arm proximate or against the coupling surface of the fixture housing further comprises:
means for disposing a spring in the latch housing;
means for causing the plunger to move further inwardly relative to the latch housing, comprising exerting a force on the plunger;
means for compressing the spring in response to causing the plunger to move further inwardly relative to the latch housing;
means for generally preventing further inward motion of the plunger relative to the latch housing; and
means for removing the force exerted on the plunger so that the spring urges at least a portion of the plunger out of the latch housing so that the at least one arm rotates outwardly.
